(19) United States
(12) Patent Application Publication
(10) Pub. No.: US 2025/0059462 A1
(43) Pub. Date: Feb. 20, 2025

(54) SHORT-PATH EVAPORATION PROCESSES

(71) Applicant: Cargill, Incorporated, Wayzata, MN (US)

(72) Inventors: Falk Bruese, Drensteinfurt (DE); Dimitris Lykomitros, Wormer (NL); Gijsbertus Johannes Van Rossum, Spijkenisse (NL)

(73) Assignee: Cargill, Incorporated, Wayzata, MN (US)

(21) Appl. No.: 18/721,669

(22) PCT Filed: Dec. 20, 2022
(86) PCT No.: PCT/US2022/082036

§ 371 Date: Jun. 19, 2024

(30) Foreign Application Priority Data
Dec. 21, 2021 (EP) 21216696.1

(51) Int. Cl. C11B 3/12

(52) U.S. Cl. CPC C11B 3/12

(57) ABSTRACT

The present invention relates to processes for removing impurities from an edible fat, such as an edible butter or edible oil, where the processes comprise the step of subjecting the edible fat to a short-path evaporation process and do not comprise the step of bleaching the edible fat, and/or subjecting the edible fat to clay filtration.

### CROSS-REFERENCE TO RELATED APPLICATIONS

This application claims the benefit of European Patent Application No. 21216696.1, filed Dec. 21, 2021, which is incorporated by reference herein in its entirety.

### FIELD OF THE INVENTION

The present invention relates to short-path evaporation processes. In particular, the present invention relates to short-path evaporation processes for modifying edible fats, for example edible butters (such as cocoa butters) and edible oils.

### BACKGROUND OF THE INVENTION

Unrefined edible butters, for example unrefined cocoa butters, and unrefined edible oils are commonly processed to purify and/or modify their properties. Such processes often include bleaching and/or subjecting an edible fat to clay filtration. Bleaching and/or subjecting edible butters and edible oils to clay filtration removes impurities to improve the color and flavor of the oil or butter starting material. Bleaching is typically performed prior to deodorization.

A common process for refining an unrefined butter, for example unrefined cocoa butter, or an unrefined edible oil comprises the steps of:
1. Filtering the unrefined butter, for example unrefined cocoa butter, or an unrefined edible oil to remove solid matter.
2. Degumming the product of step 1 by applying acid.
3. Applying a clay (for example a diatomaceous earth) to remove colour and other components from the product of step 2. Such a step is often referred to as bleaching because it removes colour.
4. Drying the product of step 3 to remove water.
5. Deodorizing the product of step 4 by applying steam at temperatures of 160° C. or greater.

The product of step 3 is a bleached butter, for example a bleached cocoa butter, or a bleached edible oil (depending on the starting material).

Whilst bleaching and/or subjecting edible butters and edible oils to clay filtration removes impurities to improve the color and flavor of the oil or butter starting material, such steps decrease the overall efficiency of refining processes.

There is a need to identify efficient and effective processes for modifying edible butters, for example cocoa butters, and edible oils without the problems associated with bleaching and/or clay filtration.

### SUMMARY OF THE INVENTION

The present invention relates to short-path evaporation processes for modifying edible butters, for example cocoa butters, and/or edible oils. Optionally, the edible butters and/or edible oils are unrefined edible butters, such as unrefined cocoa butters, and/or unrefined edible oils.

The present inventors surprisingly discovered that processing edible butters, for example cocoa butters, and/or edible oils, using short-path evaporation at particular temperatures provides beneficial routes to desirable products. In particular, the present inventors surprisingly discovered that subjecting an edible butter to short-path evaporation allows for the omission of one or more standard refining steps, such as omitting a bleaching step, a deodorizing step and/or a degumming step.

Representative features of the present invention are set out in the following clauses, which stand alone or may be combined, in any combination, with one or more features disclosed in the text and/or figures of the specification.

According to a first aspect of the present invention, there is provided a process for removing impurities from an edible fat, wherein the edible fat is a cocoa butter, a shea butter, a mango kernel oil, an illipe nut oil or a sal nut oil, the process comprising the step of subjecting the edible fat to a short-path evaporation on a short-path evaporation equipment having an evaporator surface, wherein the short-path evaporation is performed:
at a pressure of below 1 mbar;
at an evaporator temperature in the range of from 80 to 280° C.; and, with a feed rate per unit area of the evaporator surface of the short-path evaporation equipment in the range of from 5 to 500 kg/h·m²;
to form a retentate edible fat and a distillate;
   wherein the process does not comprise the step of bleaching the edible fat, and/or subjecting the edible fat to clay filtration.

Preferably, wherein the edible fat is a cocoa butter.

Further preferably, wherein the edible fat is a crude edible fat; optionally, wherein the crude edible fat has not previously been refined; optionally, wherein the crude edible fat has not previously been:
deodorized, or
bleached, or
degummed, or
deodorized and bleached, or
deodorized and degummed, or
bleached and degummed, or
deodorized and bleached and degummed.

Advantageously, wherein the feed rate per unit area of the evaporator surface of the short-path evaporation equipment is in the range of from 35 to 170 kg/h·m². Alternatively, the feed rate per unit area of the evaporator surface of the short-path evaporation equipment is in the range of from 100 to 300 kg/h·m²; preferably from 150 to 250 kg/h·m².

Preferably, wherein the process removes free fatty acids (FFA) from the edible fat; optionally, wherein the process removes at least 1 weight %, or at least 2 weight %, or at least 5 weight %, or at least 10 weight %, or at least 25 weight %, or at least 50 weight %, or at least 75 weight % of the FFA.

Alternatively, wherein the process removes less than 0.3% w/w of the FFA, wherein w/w is weight % of the total starting edible fat mass.

Further preferably, wherein the process removes diacyl glycerides (DAG) from the edible fat; optionally, wherein the process removes at least 25 weight %, or at least 50 weight %, or at least 75 weight % of the DAG.

Preferably, wherein the process reduces the Aroma Index of the starting material by at least 70 weight %, or at least 80 weight %, or at least 90 weight %, as expressed by the Aroma Index method, as described in Rostagno, W., Reymond, D., Viani, R. (1970), “Characterization of deodorized cocoa butter,” Revue internationale de la chocolaterie, 25: 352-353 (the disclosure of which is hereby incorporated by reference).

Advantageously, wherein the short-path evaporation is performed at a pressure below 0.01 mbar, or below 0.001 mbar; or, wherein the short-path evaporation is performed at a pressure from 0.01 mbar to 1 mbar.

Preferably, wherein the short-path evaporation is performed at a temperature of from 80 to 140° C.; or, from 80 to 100° C.; or, from 120 to 140° C.

Further preferably, wherein the short-path evaporation is performed at a temperature of from 140 to 220° C.

Advantageously, wherein the short-path evaporation is performed at a temperature of from 220 to 280° C.

Preferably, wherein the process does not comprise the step of deodorizing the edible fat by treatment with steam; optionally, wherein the process does not comprise the step of deodorizing the edible fat by treatment with steam at a temperature of from 160 to 280° C.; or, at a temperature of from 220 to 270° C.

Advantageously, wherein the short-path evaporation is performed under the following conditions:
an operating pressure of 0.001 mbar (plus or minus 10%) and an operating temperature of from 120 to 140° C.; or,
an operating pressure of 0.01 mbar (plus or minus 10%) and an operating temperature of from 130 to 150° C.; or,
an operating pressure of 0.1 mbar (plus or minus 10%) and an operating temperature of from 150 to 170° C.

Further preferably, wherein the process does not comprise the step of degumming the edible fat.

Advantageously, wherein the process does not comprise the step of drying the edible fat.

Preferably, wherein the process consists of subjecting the edible fat to a short-path evaporation, after filtering the edible fat to remove solid matter.

In a further aspect of the present invention, there is provided a retentate edible fat obtained from, or obtainable from, the process as described above.

In a further aspect of the present invention, there is provided the use of short-path evaporation performed at a pressure below 1 mbar, at a temperature of from 80 to 280° C., and a feed rate per unit area of the evaporator surface of a short-path evaporation equipment of from 5 kg/h·m² to 500 kg/h·m², for reducing the content of free fatty acids (FFA) from an edible fat, wherein the edible fat is a cocoa butter, a shea butter, a mango kernel oil, an illipe nut oil or a sal nut oil.

Preferably, wherein the use does not comprise bleaching the edible fat, and/or subjecting the edible fat to clay filtration.

Further preferably, wherein the edible fat is a cocoa butter.

Advantageously, wherein the free fatty acids (FFA) content of the edible fat is reduced by at least 1 weight %, or at least 2 weight %, or at least 5 weight %, or at least 10 weight %, or at least 25 weight %, or at least 50 weight %, or at least 75 weight %, compared to the edible fat prior to short-path evaporation.

Preferably, wherein the short-path evaporation is performed at a temperature of from 80 to 220° C.; or from 80 to 120° C.; or from 120 to 140° C.; or from 140 to 220° C.; or from 220 to 280° C.

Further preferably, wherein the use does not comprise:
deodorizing the edible fat by treatment with steam; or,
degumming the edible fat; or,
drying the edible fat; or,
deodorizing the edible fat by treatment with steam and degumming the edible fat; or,
deodorizing the edible fat by treatment with steam and bleaching the edible fat; or,
degumming the edible fat and bleaching the edible fat; or,
deodorizing the edible fat by treatment with steam and degumming the edible fat and bleaching the edible fat; or,
   deodorizing the edible fat by treatment with steam and degumming the edible fat and bleaching the edible fat and drying the edible fat.

### DETAILED DESCRIPTION

Aspects of the present invention are described below with reference to the accompanying drawings. The accompanying drawings illustrate various non-limiting aspects of systems, processes, and aspects of various other examples of the present invention.

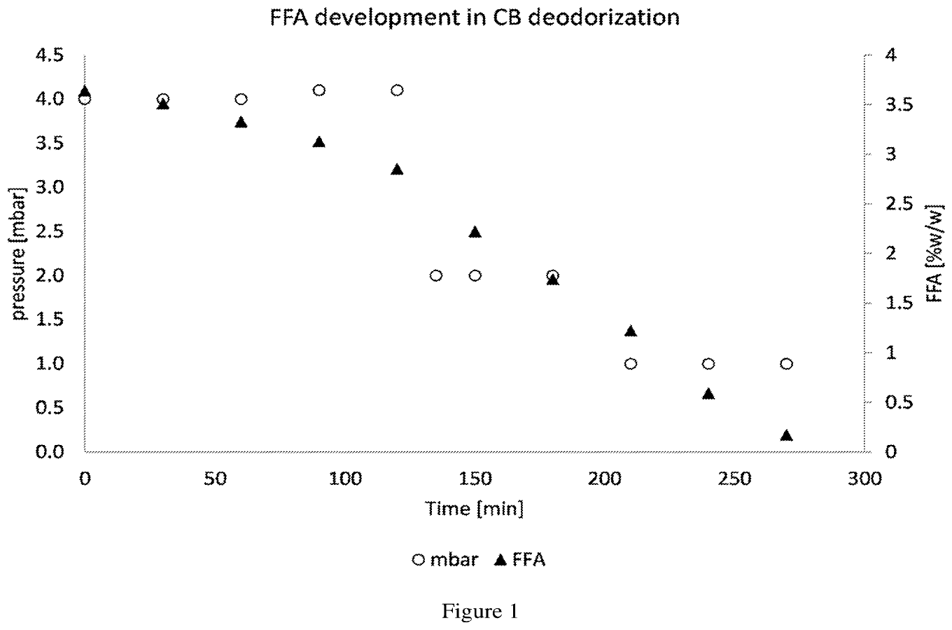

FIG. 1 shows FFA development during deodorization of sample CB5.

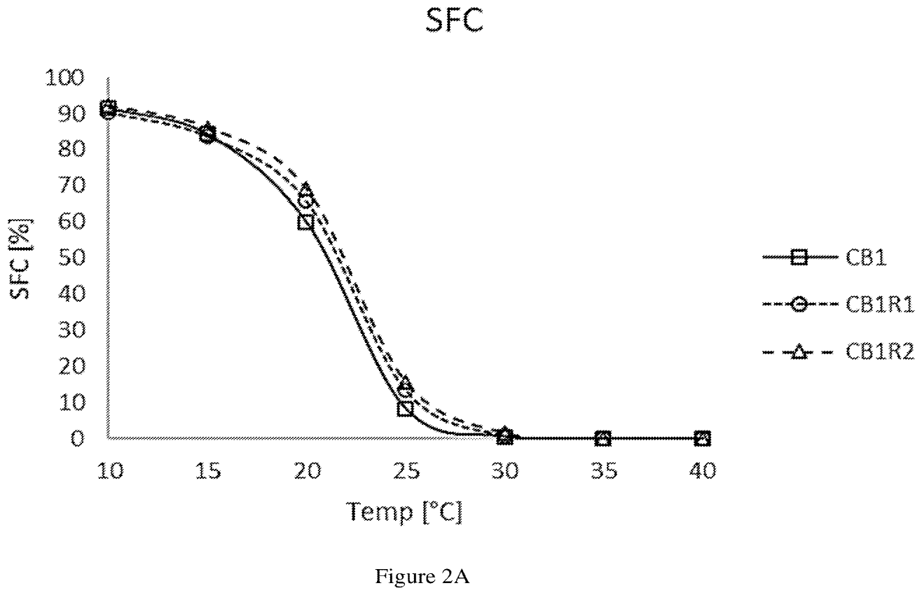

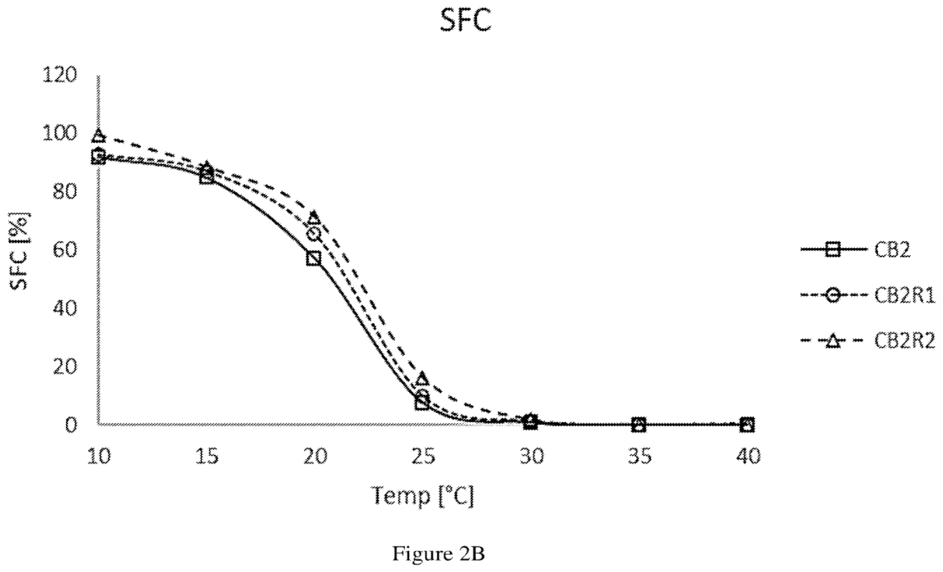

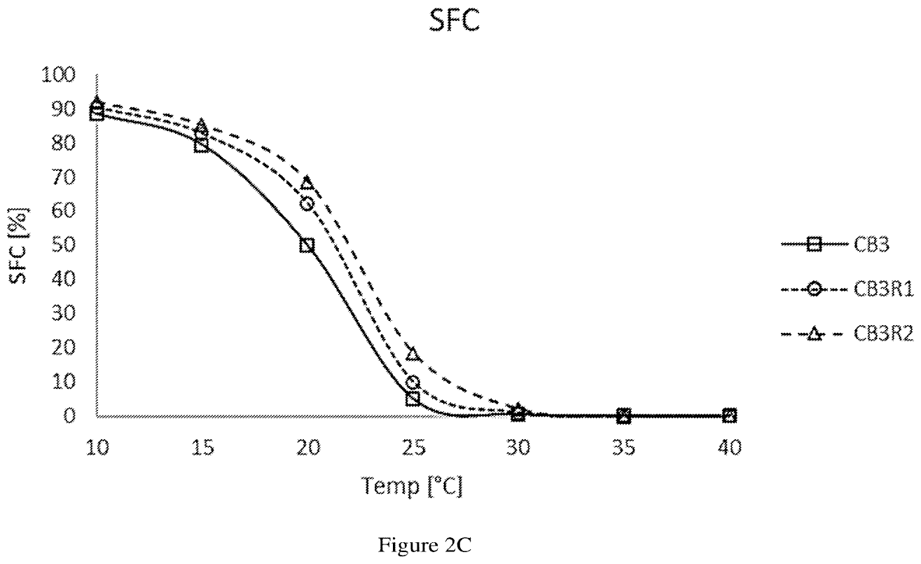

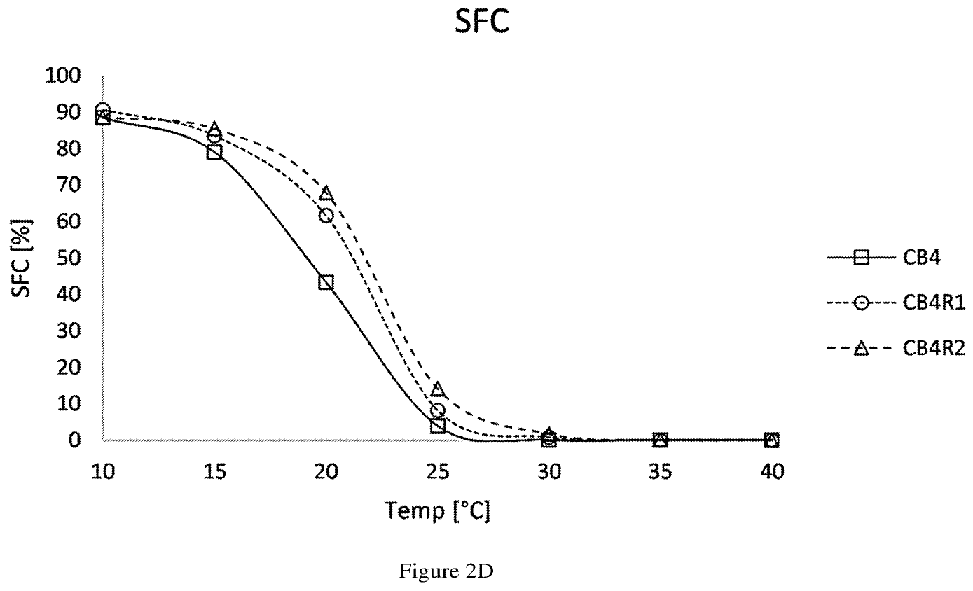

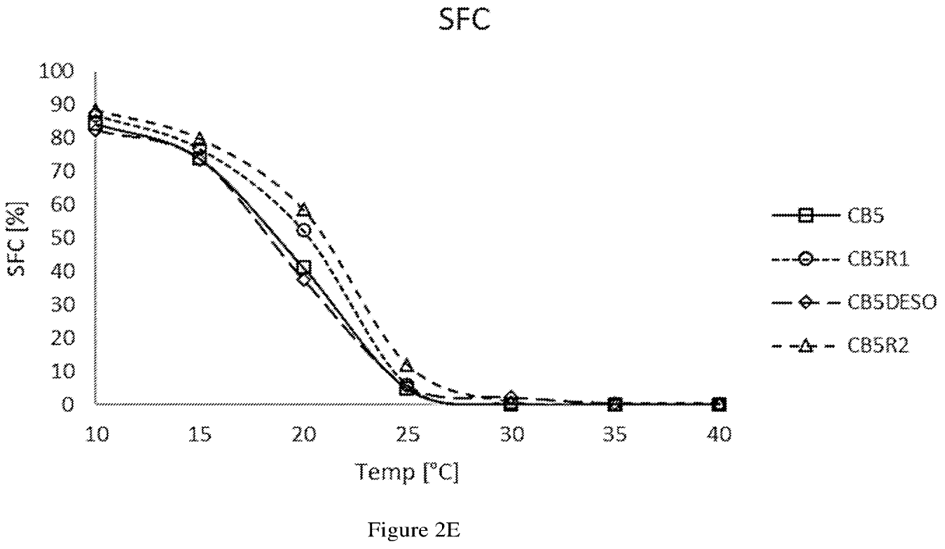

FIGS. 2A-E show SFC differences for different CB samples before and after FFA removal by SPE.

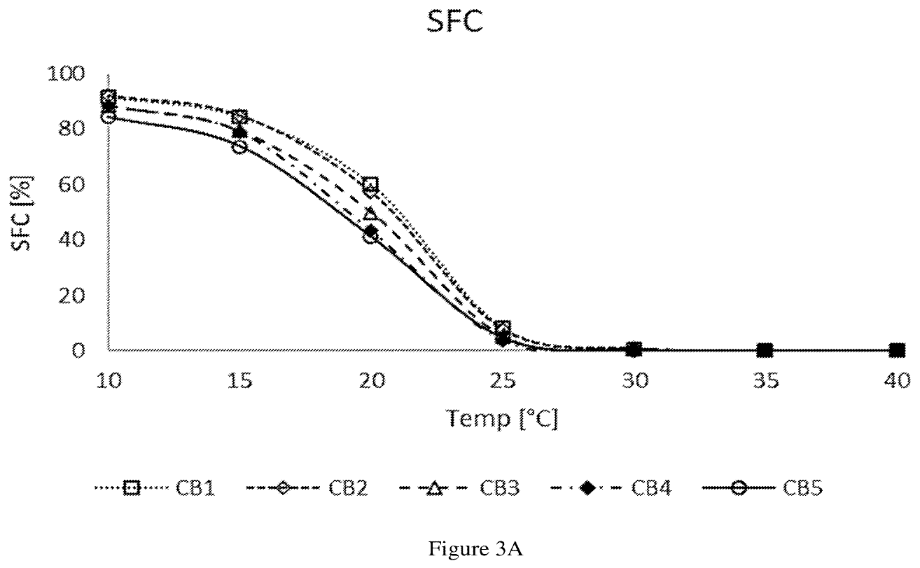

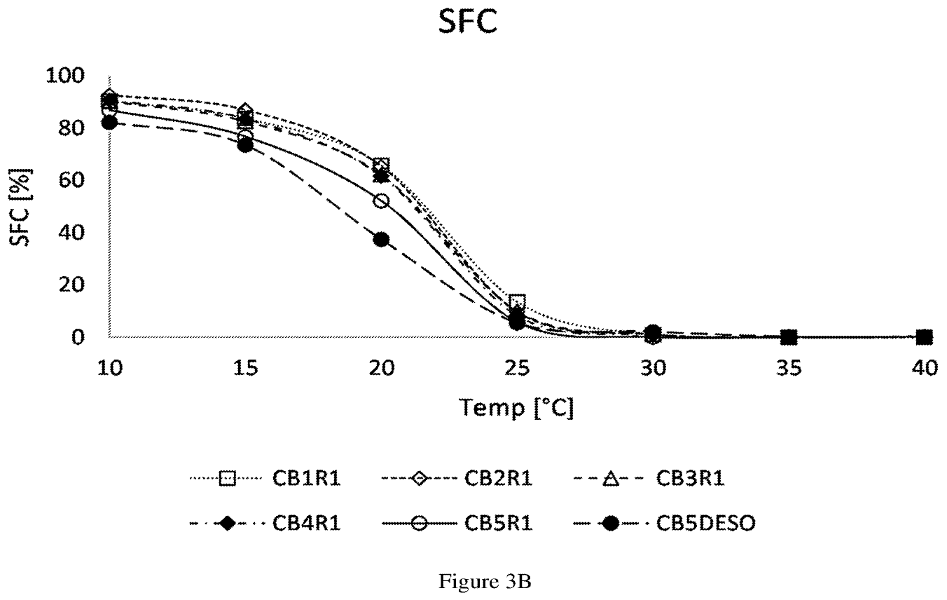

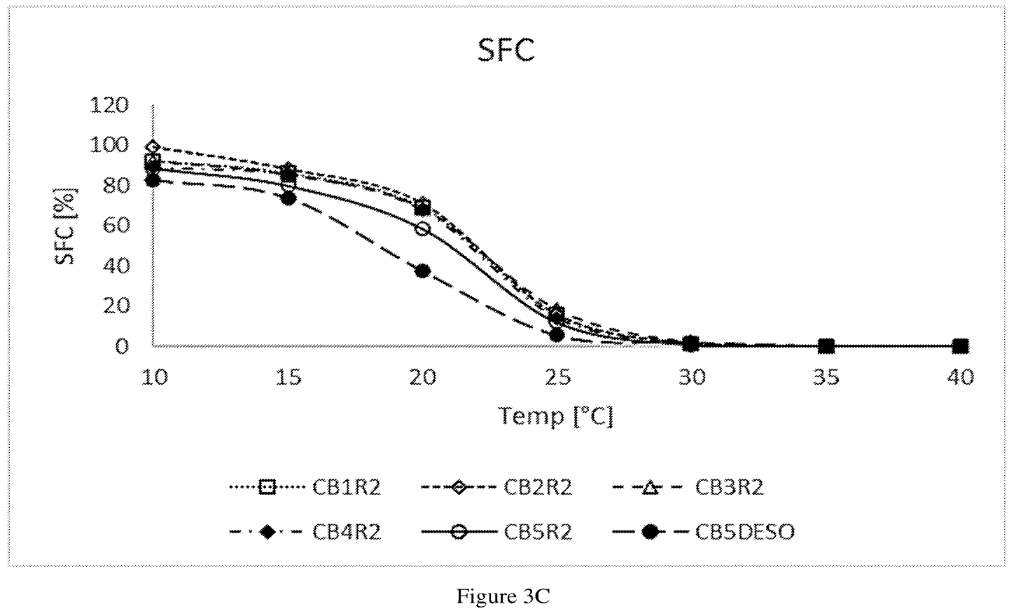

FIGS. 3A-C show SFC comparisons for different CB samples starting with different FFA levels under different reaction conditions.

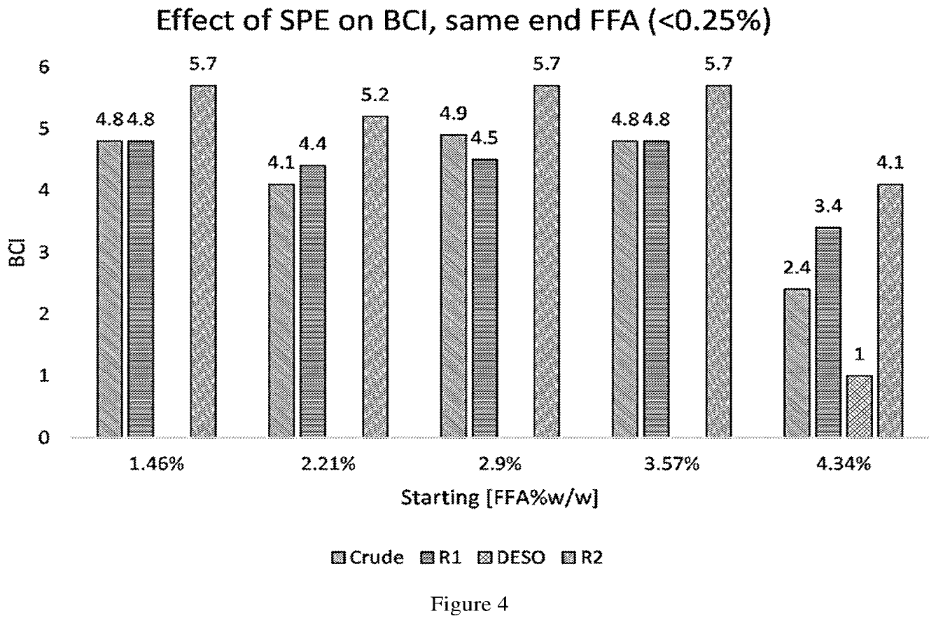

FIG. 4 shows BCI (Bühler Crystallization Index) for different CB samples pre and post SPE treatment with a constant end FFA %.

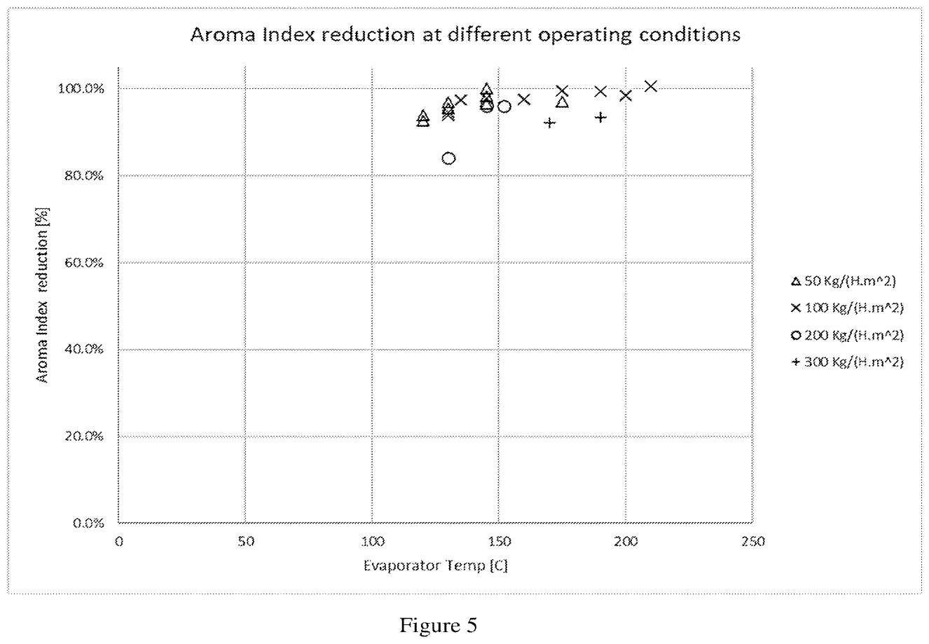

FIG. 5 shows the reduction of the Aroma Index for different SPE treatments of a raw cocoa butter.

Aspects of the present invention will be described more fully hereinafter with reference to the accompanying drawings in which like numerals represent like elements throughout the several figures, and in which example aspects are shown. Aspects of the claims may, however, be embodied in many different forms and should not be construed as limited to the aspects set forth herein.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and processes similar or equivalent to those described herein can be used in the practice or testing of aspects of the present invention, the preferred systems and processes are now described.

Some of the terms used to describe the present invention are set out below:

“Aroma Index” or “AI” refers to a chocolate industry standard measure of the degree of deodorization. The method includes steam distilling a cocoa butter and measuring the absorbance by spectrophotometry at 278 nm of a given volume of the resulting distillate, as described in Rostagno, W., Reymond, D., Viani, R. (1970), “Characterization of deodorized cocoa butter,” Revue internationale de la chocolaterie, 25: 352-353 (the disclosure of which is hereby incorporated by reference). The Aroma Index primarily corresponds to the presence of nitrogen heterocyclic compounds, esters and aliphatic acids, which are frequently correlated with the organoleptic properties of cocoa butter. The lower the Aroma Index, the lower the content of nitrogen heterocyclic compounds, esters and aliphatic acids and therefore the lower the undesirable taste and/or smell of the cocoa butter.

“Bühler Crystallization Index” or “BCI” refers to a crystallization index developed by the company Bühler Holding AG (and its associated companies). The BCI provides information about the crystallization behaviour of cocoa butter and cocoa mass.

“Cocoa butter” or “CB”, also called “theobroma oil”, refers to a pale-yellow, edible fat obtained from cocoa beans. Cocoa beans are typically fermented and then dried. The beans may then be roasted and are separated from their hulls to produce cocoa nibs. Typically, from 50 to 60% by weight of cocoa nibs is cocoa butter. The cocoa nibs are ground to form cocoa mass which is a liquid at temperatures above the melting point of cocoa butter and is sometimes called cocoa liquor or chocolate liquor. Cocoa mass is pressed to separate the cocoa butter (unrefined) from the non-fat cocoa solids. Unrefined cocoa butter often includes free fatty acids which provide strong and/or undesirable tastes and/or smells. Cocoa butter comprises a high proportion of saturated fats.

“Diglycerides” or “DAG” or “diacylglycerols” refers to glycerides comprising two fatty acid chains covalently bonded to a glycerol molecule through ester linkages. Diacylglycerols can acts as surfactants and are sometimes used as emulsifiers in food production.

“Edible fat” refers to a lipid composition that is suitable for human and/or animal consumption. As used herein, the term may refer to edible fats in their crude (unrefined), partially-refined or refined form, and includes both edible butters and edible oils.

“Edible butter” refers to an edible fat which is solid at room temperature (20° C.) and normal atmospheric pressure (1 atm). Non limiting examples of edible butters suitable for use in the present invention include cocoa butter and shea butter. Additional non limiting examples of edible butters suitable for use in the present invention include illipe nut oil, mango kernel oil, and sal nut oil (whilst these edible butters are referred to as oils they are solid at room temperature (20° C.) and normal atmospheric pressure (1 atm)).

“Edible oil” refers to an edible fat which is liquid at room temperature (20° C.) and normal atmospheric pressure (1 atm). Non limiting examples of edible oils suitable for use in the present invention include sunflower oil, soybean oil, rapeseed oil and linseed oil.

“Free fatty acids” or “FFA” refers to chemical compounds including a carboxylic acid with an aliphatic chain, which aliphatic chain can be either saturated or unsaturated. Cocoa butter, and other edible butters and edible oils, include free fatty acids. By way of a non-limiting example, cocoa butter can include stearic acid, palmitic acid, oleic acid, linoleic acid and arachidic acid. It is often desired to remove free fatty acids from edible butters (for example cocoa butter) and edible oils because free fatty acids impart a smell and/or a taste to the edible butter or edible oil, which smell and/or taste is undesirable in one or more end products. Some countries require the removal of free fatty acids from edible butters (for example cocoa butter) and edible oils, below certain thresholds, before food products can be placed on the market.

“Gel Permeation Chromatography” or “GPC” refers to a type of size-exclusion chromatography that separates analytes on the basis of size. A mixture of components can be separated using GPC.

“Illipe nut oil”, also called “illipe butter”, refers to a vegetable fat from the nut of the Shorea stenoptera tree. Illipe nut oil is edible and is sometimes mixed with other fats as a substitute for cocoa butter in food preparations.

“MOSH/MOAH” refers to Mineral Oil Saturated Hydrocarbons (MOSH) and Mineral Oil Aromatic Hydrocarbons (MOAH), both of which are types of mineral oil hydrocarbons. Mineral oil hydrocarbons are a complex mixture of molecules that may be present as contaminants in edible fats, as well as in foods prepared therewith. MOSH are linear and branched alkanes and/or cyclo-alkanes. MOAH consists of highly alkylated mono- and/or polycyclic aromatic hydrocarbons.

“Mango kernel oil”, also called “mango kernel fat” or “mango butter”, refers to a seed oil extracted from the stone of the mango fruit (from the Mangifera indica tree). Mango kernel oil is a soft yellow colour. Mango kernel oil is edible and is sometimes mixed with other fats as a substitute for cocoa butter in food preparations.

“Polyaromatic hydrocarbons” or “PAH” refers to chemical compounds comprising only carbon and hydrogen formed in multiple aromatic rings. Non-limiting examples of polyaromatic hydrocarbons include naphthalene, anthracene, phenanthrene, biphenyl, fluorene, phenalene, tetracene and chrysene. Polyaromatic hydrocarbons have been linked with cardiovascular disease and cancers. Therefore, it is desirable to remove polyaromatic hydrocarbons from food products.

“Sal nut oil” refers to an edible oil extracted from the seeds of the Shorea robusta tree. Shorea robusta is known as the Sal tree in India. Sal nut oil is edible and is sometimes mixed with other fats as a substitute for cocoa butter in food preparations.

“Shea butter” refers to an ivory coloured fat extracted from the nut of the African shea tree (Vitellaria paradoxa). Shea butter is edible and is sometimes mixed with other fats as a substitute for cocoa butter in food preparations.

“Short-path evaporation” or “SPE” is also referred to as “short-path distillation” or “molecular distillation”. “Short-path evaporation” is a distillation technique that involves the distillate travelling a short distance, often only a few centimetres, and it is normally done at reduced pressure. With short-path evaporation, a decrease of boiling temperature is obtained by reducing the operating pressure. It is a continuous process with very short residence time. In short-path evaporation processes of the present invention, the starting material may be subjected to one, two, three, four, five, six or more rounds of short-path evaporation.

“Solid fat content” or “SFC” refers to a measure of the percentage of fat in crystalline (solid) phase to total fat (the remainder being in the liquid phase) across a temperature gradient. SFC is often expressed at a particular temperature as NXX where the NXX value is the weight percentage of fat crystalized at a given temperature (where “XX” is the given temperature in ° C.). One non-limiting example of a method of measuring SFC is the non-tempered method IUPAC 2.150a. Another non-limiting example of a method of measuring SFC is the tempered method IUPAC 2.150b.

“Triglycerides”, sometimes referred to as “triacylglycerols” or “TAG”, refers to a glyceride comprising three fatty acid chains covalently bonded to a glycerol molecule through ester linkages. Triglycerides are the main constituents of, among other things, vegetable fats.

“Weight %” refers to the percentage weight in grams of a component of a composition in every 100 grams of that composition. For example, if a composition contains 10 weight % of component A, then there is 10 g of component A for every 100 g of the composition.

### Short-Path Evaporation

The present invention relates to short-path evaporation processes for modifying edible fats such as cocoa butter.

Short-path evaporation is often used to remove compounds which are unstable at high temperatures or to purify small amounts of compounds. The advantage is that the heating temperature can be considerably lower (at reduced pressure) than the boiling point of the liquid at standard pressure. Additionally, short-path evaporation allows working at very low pressure.

Different types of short-path evaporation apparatus can be used that are well known to the skilled person. Examples are, but are not limited to, falling film, centrifugal, or wiped film evaporation apparatus. Preferably the short-path evaporation of the current process is performed in a wiped film evaporation apparatus.

The short-path evaporation is performed at a pressure below 1 mbar, preferably below 0.05 mbar, more preferably below 0.01 mbar, most preferably below 0.001 mbar.

The short-path evaporation is further performed at specific conditions of evaporator temperature and feed rate per unit area of evaporator surface of the short-path evaporation equipment.

The “feed rate per unit area of evaporator surface of the short-path evaporation equipment”, also called “specific throughput” or “specific feed rate”, expressed in kg/h·m², is defined as the flow of butter or oil, expressed in kg/h, per unit area of evaporator surface of the short-path evaporation equipment, expressed in m² (square meter). The feed rate per unit area of evaporator surface of the short-path evaporation equipment in the process of the current invention is applicable to any short-path equipment, including industrial short-path evaporation equipment independent of the dimensions of the equipment. Preferably stainless steel short-path evaporation equipment is used in the current invention.

Short-path evaporation according to the present invention can be performed:
at a pressure of below 1 mbar;
at an evaporator temperature in the range of from 80 to 280° C.; and, with a feed rate per unit area of the evaporator surface of the short-path evaporation equipment in the range of from 5 to 500 kg/h·m²;
   to form a retentate edible fat and a distillate.

When the short-path evaporation is performed at a temperature of from 80 to 140° C., or from 140 to 220° C., some or all of the FFA is removed from the edible fat starting material (for example cocoa butter). When the temperature of the short-path evaporation is increased to from 220 to 280° C., in addition to FFA, some or all of the DAG is removed from the edible fat starting material (for example cocoa butter).

When the short-path evaporation is performed at a temperature from 120 to 140° C. only some or all of the FFA is removed, and a greater than 80% reduction in the Aroma Index can be achieved (resulting in the effective deodorization of cocoa butter, without steam use). The present inventors discovered that different combinations of operating temperatures and operating pressures lead to synergistic results. For example:
An operating pressure of 0.001 mbar, and an operating temperature of from 120 to 140° C., results in some FFA removal and a greater than 80% reduction in Aroma Index.
An operating pressure of 0.01 mbar, and an operating temperature of from 130 to 150° C., results in some FFA removal and a greater than 80% reduction in Aroma Index.
An operating pressure of 0.1 mbar, and an operating temperature of from 150 to 170° C., results in some FFA removal and a greater than 80% reduction in Aroma Index.

In the process according to the invention, two fractions are obtained from the short-path evaporation: a retentate oil or butter, and a distillate.

The yield of the retentate oil or butter of the short-path evaporation is preferably more than 80%, more than 90%, more than 95%, or even more than 97%. The yield is expressed as the ratio of the amount of retentate butter or oil that is obtained versus the amount of butter or oil that was subjected to the short-path evaporation.

More specifically, the short-path evaporation of the current process results in edible fats that have a reduced FFA content. Advantageously, the FFA content is reduced by at least 25%, at least 30%, at least 40%, or even at least 50%. The FFA content may be reduced in a range of from 25% to 75%, from 27% to 70%, or from 30% to 65%. Preferably, the yield of the retentate butter or oil of the short-path evaporation is more than 95%, more than 97%, more than 98%, or even more than 99%. Alternatively, the FFA content can be reduced by from 0.05 to 0.5% if the primary focus of the short-path evaporation is deodorization.

Advantageously, the short-path evaporation processes of the present invention result in edible butters and/or edible oils with reduced or substantially no odorant content (non-limiting examples of odorants include aldehydes, pyrazines, organic acids, ketones, phenols, furans, alcohols and sulfur-containing compounds), reduced or substantially no DAG content, reduced or substantially no PAH content, and reduced or substantially no MOSH/MOAH content.

### Starting Material

In one aspect of the invention, an edible fat (for example cocoa butter) is subjected to short-path evaporation but is not degummed, bleached and/or deodorized

Despite omitting one or more of these steps (i.e. degumming, bleaching and/or deodorization), the produced fat is still in a form for commercial use.

The starting material can be any edible fat selected from: cocoa butter, shea butter, mango kernel oil, illipe nut oil, sal nut oil and mixtures of any two, three, four or five thereof. The starting material may include, or may consist of, crude, partially refined, and/or refined edible fats. Typically, the starting material will be crude, in the sense that it has not previously been refined. By not previously refining the starting material, the crude starting material has not previously been:
deodorized, or
bleached, or
degummed, or
deodorized and bleached, or
deodorized and degummed, or
bleached and degummed, or
deodorized and bleached and degummed.

The present invention provides beneficial processes for purifying and/or modifying the starting materials whilst removing or minimising the number of other process steps.

Preferably, the starting material is cocoa butter. The cocoa butter may be of any origin, that is from any type of cocoa bean (e.g. from Ghana, Ivory Coast, Nigeria, Cameroon, Indonesia, or Brazil). The cocoa butter starting material may be, or may include, a cocoa butter of poor quality (such as that from Cameroon cocoa beans or cocoa butter that has spoilt). In that case, the process of the present invention can be used to recover quality (that is, to produce a refined cocoa butter of good quality). Poor quality cocoa butter typically has an FFA content of greater than 1.75% by weight and/or has poor organoleptic properties (i.e. off-flavours). Alternatively, the cocoa butter starting material may be, or may include, a good quality cocoa butter. The process of the present invention may then be used to produce a refined cocoa butter of premium quality. Premium quality cocoa butter typically has an FFA content of lower than 1.0% by weight (sometimes even less than 0.5% by weight) and has good organoleptic properties (i.e. no off-flavours). The starting material may include, or may consist of, crude cocoa butter, partially refined cocoa butter, and/or refined cocoa butter. Alternatively, good quality cocoa butter (with a starting FFA content less than or equal to 1.75% by weight) can be deodorized using short-path evaporation at a relatively low temperature (for example less than 150° C.), resulting in further quality preservation and energy savings.

When cocoa butter is used as (or as part of) the starting material, the refined edible fat obtainable according to the process of the present invention will advantageously have an FFA content of maximum 1.75% by weight, such as from 0.0 to 1.75% by weight, from 0.1 to 1.5% by weight, from 0.2 to 1.2% by weight, from 0.3 to 1.0% by weight, from 0.4 to 0.8% by weight or about 0.5% by weight (optionally, expressed as oleic acid equivalent). The refined edible fat may also have a reduced or substantially no odorant content, a reduced or substantially no DAG content, a reduced or substantially no PAH content, and a reduced or substantially no MOSH/MOAH content.

### Degumming

Crude fat (for example crude cocoa butter) may be subjected to one or more degumming steps. A degumming step may be omitted in the processes of the presently claimed invention. Any of a variety of degumming processes known in the art may be used (or omitted).

One such degumming process (known as “water degumming”) includes mixing water with the fat and separating the resulting mixture into a fat component and a fat-insoluble hydrated phosphatides component, sometimes referred to as “wet gum” or “wet lecithin”. Alternatively, phosphatide content can be reduced (or further reduced) by other degumming processes, such as acid degumming (using citric or phosphoric acid for instance), enzymatic degumming (e.g. ENZYMAX from Lurgi) or chemical degumming (e.g. SUPERIUNI degumming from Unilever or TOP degumming from VandeMoortele/Dijkstra CS). Alternatively, phosphatide content can also be reduced (or further reduced) by means of acid conditioning, wherein the fat is treated with acid in a high shear mixer and is subsequently sent without any separation of the phosphatides to an optional bleaching step.

Omitting one or more, or all, degumming steps leads to higher efficiency (i.e. reduces energy use per unit of produced product) whilst still producing a refined product, i.e. a retentate edible fat, which can be used in food production. Omitting one or more, or all, degumming steps additionally leads to one or more benefits of: simplified operations (fewer process steps); improved yield (some butter is usually lost with the gums); reduced opportunity for further hydrolysis and/or crystallization property degradation.

### Bleaching

A bleaching step in general is a process step whereby impurities are removed to improve the color and flavor of the oil or butter starting material. Bleaching is typically performed prior to deodorization. A bleaching step may be omitted in the processes of the presently claimed invention. The nature of the bleaching step will depend, at least in part, on the nature and quality of the fat being bleached.

Generally, a crude or partially refined fat will be mixed with a bleaching agent which combines, amongst others, with oxidation products, phosphatides, trace soaps, pigments and other compounds to enable their removal. The nature of the bleaching agent can be selected to match the nature of the crude or partially refined fat to yield a desirable bleached fat. Bleaching agents generally include natural or “activated” bleaching clays, also referred to as “bleaching earths”, activated carbon and various silicates. Natural bleaching agent refers to non-activated bleaching agents. They occur in nature or they occur in nature and have been cleaned, dried, milled and/or packed ready for use. Activated bleaching agent refers to bleaching agents that have been chemically modified, for example by activation with acid or alkali, and/or bleaching agents that have been physically activated, for example by thermal treatment. Activation includes the increase of the surface in order to improve the bleaching efficiency.

Further, bleaching clays may be characterized based on their pH value. Typically, acid-activated clays have a pH value of from 2.0 to 5.0. Neutral clays have a pH value of from 5.5 to 9.0.

A skilled person will be able to select a suitable bleaching agent from those that are commercially available based on the fat being refined and the desired end use of that fat.

The bleaching step for obtaining a bleached fat, can be performed at a temperature of from 80 to 115° C., from 85 to 110° C., or from 90 to 105° C., in the presence of bleaching earth in an amount of from 0.2 to 5 wt. %, from 0.5 to 3 wt. %, or from 0.7 to 1.5 wt. % based on amount of fat.

Omitting one or more, or all, bleaching steps leads to higher efficiency (i.e. reduces energy use per unit of produced product and minimises the reaction steps) whilst still producing a refined product, i.e. a retentate edible fat, which can be used in food production. Omitting one or more, or all, bleaching steps additionally leads to one or more benefits of: simplified operations (fewer process steps); improved yield; reduced opportunity for further hydrolysis and/or crystallization property degradation.

### Deodorization

Deodorization is a process whereby free fatty acids (FFAs) and other volatile impurities (e.g. nitrogenous heterocyclic compounds) are removed by treating (or “stripping”) a crude or partially refined fat under vacuum and at elevated temperature with sparge steam, nitrogen or other gases. The deodorization step may be omitted in the processes of the presently claimed invention. The deodorization process and its many variations and manipulations are well known in the art and the deodorization step of the present invention may be based on a single variation or on multiple variations thereof.

For instance, deodorizers may be selected from any of a wide variety of commercially available systems (such as those sold by Krupp of Hamburg, Germany; De Smet Group, S.A. of Brussels, Belgium; Gianazza Technology s.r.l. of Legnano, Italy; Alfa Laval AB of Lund, Sweden, Crown Ironworks of the United States, or others). The deodorizer may have several configurations, such as horizontal vessels or vertical tray-type deodorizers.

Deodorization is typically carried out at elevated temperatures and reduced pressure to better volatilize the FFAs and other impurities. The precise temperature and pressure may vary depending on the nature and quality of the fat being processed. The pressure, for instance, will preferably be no greater than 10 mm Hg but certain aspects of the invention may benefit from a pressure below or equal to 5 mm Hg, e.g. from 1 to 4 mm Hg. The temperature in the deodorizer may be varied as desired to optimize the yield and quality of the deodorized oil. At higher temperatures, reactions which may degrade the quality of the oil will proceed more quickly. For example, at higher temperatures, cis-fatty acids may be converted into their less desirable trans form. Operating the deodorizer at lower temperatures may minimize the cis-to-trans conversion, but will generally take longer or require more stripping medium or lower pressure to remove the requisite percentage of volatile impurities. As such, deodorization is typically performed at a temperature of the oil in a range of 200 to 280° C., with temperatures of about 220-270° C. being useful for many oils. For cocoa butter-based oil, a deodorization temperature in a range of 130 to 220° C. is advised. Typically, deodorization occurs in a deodorizer whereby volatile components such as FFAs and other unwanted volatile components that may cause off-flavors in the fat, are removed. Deodorization may also result in the thermal degradation of unwanted components.

A deodorization step for obtaining a deodorized fat, is typically performed at a temperature of from 160° C. to 270° C., from 170° C. to 260° C., or from 180° C. to 250° C. The deodorization step takes place for a period of time from 30 min to 240 min, from 45 min to 180 min, or from 60 min to 150 min.

A deodorization step for obtaining a deodorized fat, is typically performed in the presence of sparge steam in a range of from 0.50 to 2.50 wt %, from 0.75 to 2.00 wt %, from 1.00 to 1.75 wt %, or from 1.25 to 1.50 wt % based on amount of fat, and at an absolute pressure of 10 mbar or less, 7 mbar or less, 5 mbar or less, 3 mbar or less, 2 mbar or less.

Typically, a degummed, bleached and deodorized fat is known to be obtained by means of 2 major types of refining processes, i.e. a chemical or a physical refining process. The chemical refining process may typically comprise the major steps of degumming, alkali refining, also called neutralization, bleaching and deodorizing. The thus obtained deodorized fat is a chemically refined fat; in the case of an oil starting material this is also called “NBD” oil. Alternatively, the physical refining process may typically comprise the major steps of degumming, bleaching and deodorizing. A physical refining process does not comprise an alkali neutralization step as is present in the chemical refining process. The thus obtained deodorized fat is a physically refined oil; in the case of an oil starting material this is also called “RBD” oil.

Omitting one or more, or all, deodorization steps leads to higher efficiency (i.e. reduces energy use per unit of produced product and minimises the reaction steps) whilst still producing a refined product, i.e. a retentate edible fat, which can be used in food production. In particular, using short-path evaporation in place of deodorization removes free fatty acids from unrefined edible fats, such as cocoa butters, without degrading the product by formation of trans fatty acids or interestification at higher temperatures. The avoidance of higher temperatures also leads (depending on the starting material) to lower levels of process contaminants such as 3-MCPDE and/or glycidyl esters in the product. Using short-path evaporation in place of deodorization, at high enough temperatures, leads additionally to the removal of diglycerides from unrefined edible fats, such as cocoa butters, to improve flavour and crystallization properties. Omitting one or more, or all, deodorization steps additionally leads to one or more benefits of: simplified operations (fewer process steps); improved yield; reduced opportunity for further hydrolysis and/or crystallization property degradation.

### EXAMPLES

The following are non-limiting examples that discuss, with reference to tables and figures, some of the advantages of the present invention. The examples set forth herein are non-limiting examples and are merely examples among other possibilities.

The effect of short path evaporation (SPE) and deodorization on different cocoa butter samples (starting materials) with different amounts of FFA (free fatty acids) was tested. SPE was undertaken on the cocoa butter samples, while deodorization was additionally applied to the highest FFA sample as a comparison. In a further set of tests at increased SPE temperature, also the DAG content of the samples was reduced and the effect on SFC (solid fat content) and BCI was tested.

Cocoa Butter (CB) is delivered to food producers and other consumers with a specification of maximum 1.75% by weight FFA. A maximum 1.75% by weight FFA (optionally, expressed as oleic acid equivalent) in cocoa butter is a regulatory requirement in the EU and a trade specified specification in other countries, for example in the USA. In comparison, vegetable oils are delivered to food producers and other consumers with a specification of maximum 0.10% by weight FFA.

Deodorization of CB is commonly undertaken at a temperature of 160° C. (plus or minus 10° C.) and has a marginal effect on FFA content (a reduction in FFA content of from 0.1 to 0.2% by weight), meaning that this type of deodorization cannot be used to bring “Out Of Spec” (i.e. high FFA content) cocoa butter back to below 1.75% by weight FFA.

Deodorization and short path evaporation (SPE) were evaluated to reduce FFA to normal vegetable oil levels. Such products can then be mixed again with “Out Of Spec” (i.e. higher FFA content) cocoa butter to produce cocoa butter with a maximum 1.75% by weight FFA (i.e. “In Spec” cocoa butter).

Whilst the examples relate to cocoa butter, similar or the same results are expected when treating unrefined shea butter, mango kernel oil, illipe nut oil or sal nut oil with the same or a similar SPE process.

### Example 1

### Summary

The present inventors evaluated the effect of deodorization (as a comparative reference; CB5Deso in Table 2) and SPE on Cocoa Butter when starting with different FFA levels. Furthermore, no bleaching step was performed and the products had suitable levels of impurities.

A cocoa butter with relatively high FFA content will usually also have a relatively high DAG content. The present inventors also studied high FFA containing cocoa butter after removal of the FFA, to see if the remaining DAG content led to any change (worsening) in cocoa butter properties.

### Materials

Cocoa butter samples were received from the Cocoa & Chocolate group within Cargill®. The cocoa butter samples were numbered CB1 through to CB5 and their FFA contents are listed in Table 1. All cocoa butters (CB1 through to CB5) were of the same origin (Ivory Coast) and crop year (2020). CB1 through to CB5 were filtered (through filters with 20 μm openings) to remove large particles but were otherwise crude (unrefined) starting materials.

TABLE 1
FFA Content of cocoa butter samples

| Sample | FFA/weight % |
|---|---|
| CB1 | 1.46 |
| CB2 | 2.21 |
| CB3 | 2.9 |
| CB4 | 3.57 |
| CB5 | 4.34 |

### Deodorization of CB5

Deodorization was undertaken in a lab scale unit at the Global Edible Oil Solutions—Product and Process Development group within Cargill® on a 500 g sample of CB5. CB5 was deodorized for 2 h at 240° C. and 4 mbar, with 0.5 wt % strip steam/h.

Because FFA was still above 3%, the pressure was reduced to 2 mbar for 1 h and then down to 1 mbar. After 4.5 h, FFA of 0.17 weight % was achieved. FIG. 1 shows the FFA development during deodorization of sample CB5

### Short Path Evaporation of CB1-CB5

Short path evaporation was undertaken using a KDL5 Unit from the short path evaporator producing company UIC. 180° C. evaporator temperature and a flow rate of 350 ml/h were applied for the removal of FFA. The KDL5 unit had a glass surface area of 0.05 m². Therefore, with a flow rate of 350 ml/h and a starting material density of 0.8 g/ml, the feed rate per unit area was 5.6 kg/h·m². (Reaction conditions R1).

### Reaction Conditions R1:

Feed temperature: 80° C.
Evaporator temp.: 180° C.
Condenser temp.: 70° C.
Retentate temp.: 100° C.
Wiper speed: 366 rpm
Pressure: below 10⁻³ mbar
Test conditions: 0.35 liter/h

A KDL5 unit was used for the example tests. A KDL5 unit has a glass SPE surface. If instead a unit with a stainless steel surface (such as a KD6) had been used, the corresponding feed rate per unit area would be higher due to the difference in heat transfer efficiency between glass and steel. All of the data were collected on a KDL5 unit. However, the conversion factor for the equivalent feed rate per unit area between a KDL5 unit (with a glass SPE surface) and a KD6 unit (with a stainless steel SPE surface) is 6.7. Therefore, a feed rate per unit area of 5.6 kg/h·m² on a KDL5 unit is equivalent to a feed rate per unit area of 37.52 kg/h·m² on a KD6 unit (or other SPE unit with a stainless steel SPE surface). In other examples, the feed rate per unit area can be increased to 50 kg/h·m², 100 kg/h·m², 200 kg/h·m², 300 kg/h·m², 400 kg/h·m² or 500 kg/h·m².

For the removal of DAG, the SPE evaporator temperature was increased to 240° C.; all other reaction conditions remained the same as R1. (Reaction conditions R2).

### Reaction Conditions R2:

Feed-temperature: 80° C.
Evaporator Temp.: 240° C.
Condenser Temp.: 70° C.
Retentate Temp.: 100° C.
Wiper speed: 366 rpm
Pressure: below 10⁻³ mbar
Test conditions: 0.35 liter/h

Short path evaporation was undertaken on the 5 different CB samples indicated in Table 1. Table 2A shows the characteristics of the starting materials (i.e. the 5 different CB samples indicated in Table 1). Table 2B shows the product characteristics and yields after subjecting the starting materials to R1. Table 2C shows the product characteristics and yields after subjecting the starting materials to R2.

TABLE 2A
CB Starting materials

| Analysis | Unit | CB1 | CB2 | CB3 | CB4 | CB5 | CB5Deso |
|---|---|---|---|---|---|---|---|
| FFA start | wt. % | 1.46 | 2.21 | 2.9 | 3.57 | 4.34 | 4.34 |
| FFA retentate | wt. % | — | — | — | — | — | 0.17 |
| Yield of retentate | wt. % | — | — | — | — | — | — |
| SFC | | | | | | | |
| N10 | % | 91.5 | 92.0 | 88.5 | 88.5 | 84.4 | 82.3 |
| N15 | % | 84.4 | 85.0 | 79.4 | 79.0 | 73.9 | 73.6 |
| N20 | % | 60.0 | 57.2 | 49.9 | 43.3 | 41.1 | 37.5 |
| N25 | % | 8.4 | 7.8 | 5.0 | 3.9 | 4.7 | 5.5 |
| N30 | % | 0.6 | 1.0 | 0.6 | 0.1 | 0.2 | 2.1 |
| N35 | % | 0.0 | 0.2 | 0.1 | 0.1 | 0.1 | 0.2 |
| N40 | % | 0.1 | 0.0 | 0.1 | 0.1 | 0.0 | 0.1 |
| Trisat in TAG | % | 5.7 | 5.5 | 5.7 | 7.0 | 5.4 | 6.5 |
| POS in TAG | % | 42.9 | 42.1 | 43.5 | 41.3 | 42.6 | 40.4 |
| PPP in TAG | % | 0.33 | 0.22 | 0.27 | 0.86 | 0.26 | 0.59 |
| PPO in TAG | % | 20.6 | 20.1 | 20.7 | 20.4 | 20.3 | 19.9 |
| OPO in TAG | % | 5.7 | 5.5 | 5.7 | 7.0 | 5.4 | 6.5 |
| OOO in TAG | % | 0.1 | 0.2 | 0.1 | 0.0 | 0.3 | 0.3 |
| SOS in TAG | % | 23.6 | 22.3 | 23.4 | 22.4 | 23.4 | 21.6 |

TABLE 2B
Product characteristics and yields with R1

| Analysis | Unit | CB1R1 | CB2R1 | CB3R1 | CB4R1 | CB5R1 | CB5Deso |
|---|---|---|---|---|---|---|---|
| FFA start | wt. % | 1.46 | 2.21 | 2.9 | 3.57 | 4.34 | 4.34 |
| FFA retentate | wt. % | 0.04 | 0.05 | 0.05 | 0.09 | 0.14 | 0.17 |
| Yield of retentate | wt. % | 97 | 94 | 95 | 94 | 92 | — |
| SFC | | | | | | | |
| N10 | % | 90.5 | 92.6 | 90.3 | 90.7 | 86.9 | 82.3 |
| N15 | % | 83.8 | 87.0 | 82.7 | 83.6 | 76.8 | 73.6 |
| N20 | % | 65.8 | 65.4 | 62.2 | 61.6 | 52.2 | 37.5 |
| N25 | % | 13.6 | 9.7 | 10.0 | 8.2 | 5.8 | 5.5 |
| N30 | % | 0.9 | 1.1 | 1.1 | 0.9 | 0.1 | 2.1 |
| N35 | % | 0.0 | 0.0 | 0.0 | 0.0 | 0.1 | 0.2 |
| N40 | % | 0.0 | 0.2 | 0.2 | 0.1 | 0.2 | 0.1 |

Changes in Trisat in TAG, POS in TAG, PPP in TAG etc. were only measured for the higher temperature conditions of R2.

TABLE 2C
Product characteristics and yields with R2

| Analysis | Unit | CB1R2 | CB2R2 | CB3R2 | CB4R2 | CB5R2 | CB5Deso |
|---|---|---|---|---|---|---|---|
| FFA start | wt. % | 1.46 | 2.21 | 2.9 | 3.57 | 4.34 | 4.34 |
| FFA retentate | wt. % | n.a. | n.a. | n.a. | n.a. | n.a. | 0.17 |
| Yield of retentate | wt. % | 94 | 89 | 92 | 88 | 91 | — |
| SFC | | | | | | | |
| N10 | % | 92.1 | 99.3 | 91.8 | 88.6 | 88.3 | 82.3 |
| N15 | % | 86.0 | 88.4 | 85.1 | 85.4 | 79.8 | 73.6 |
| N20 | % | 69.1 | 71.4 | 68.6 | 67.9 | 58.5 | 37.5 |
| N25 | % | 15.7 | 16.1 | 18.4 | 14.1 | 11.8 | 5.5 |
| N30 | % | 1.5 | 1.7 | 2.1 | 1.7 | 0.8 | 2.1 |
| N35 | % | 0.0 | 0.1 | 0.0 | 0.1 | 0.2 | 0.2 |
| N40 | % | 0.0 | 0.2 | 0.1 | 0.0 | 0.3 | 0.1 |
| Trisat in TAG | % | 6.4 | 6.4 | 6.2 | 6.8 | 7.1 | 6.5 |
| POS in TAG | % | 42.3 | 40.8 | 43.0 | 40.7 | 41.0 | 40.4 |
| PPP in TAG | % | 0.55 | 0.31 | 0.45 | 0.81 | 1.09 | 0.59 |
| PPO in TAG | % | 20.6 | 20.0 | 20.8 | 19.9 | 20.0 | 19.9 |
| OPO in TAG | % | 6.4 | 6.4 | 6.2 | 6.8 | 7.1 | 6.5 |
| OOO in TAG | % | 0.1 | 0.4 | 0.1 | 0.0 | 0.2 | 0.3 |
| SOS in TAG | % | 22.8 | 22.0 | 23.6 | 22.3 | 22.3 | 21.6 |

Abbreviations from Table 2 not elsewhere defined:

Trisat Tri-saturated acyl glycerides
POS Glyceryl-1-palmitate-2-Oleate-3-Stearate
PPP Glyceryl Tripalmitate
PPO Glyceryl-1,2-dipalmitate-3-oleate
OPO Glyceryl-1,3-dioleate-2-palmitate
OOO Glyceryl triolate
SOS Glyceryl-1,3-distearate-2-oleate
NXX The N-value, weight percentage of fat crystalized at given
temperature (where “XX” is the given temperature in ° C.)

GPC analysis of the products (after SPE by R2) showed that significant amounts of the DAG are removed under these conditions. Quantification is difficult because there is an overlap of TAG and DAG signals. The GPC analysis was undertaken using a standard operating procedure utilised by the Global Edible Oil Solutions—Product and Process Development group within Cargill®.

### GPC Procedure

The equipment used for the GPC analysis was:
Waters™ Alliance e2695 HPLC system
Waters™ 2410 Refractive Index detector
Waters™ 2998 Photodiode Array detector
Alliance™ column oven
Waters™ Empower 3
Waters™ Styragel GPC column HR 1 (first): art. no. WAT044234
Waters™ Styragel GPC column HR 0.5 (second): art. no. WAT 044231
Waters™ Styragel Guard column: art. no. WAT054405
   The GPC equipment settings were:
Solvent flow: 0.50 ml/min
Injection volume: 50 μl
Run time: 45 minutes
Column oven temp.: 40° C.
RI detector temp.: 30° C.
RI sensitivity: 64
PDA detector: channels λ=233 nm, 268 nm, 446 nm
   The solvents and chemicals used were:
Tetrahydrofuran HPLC grade, stabilized with BHT: CAS #109-99-9,
Sulfuric acid, concentrated 98-100%: CAS #7664-93-9
Sodium Sulfate: CAS #7757-82-6

### SFC Procedure

Solid fat content analysis (SFC) based on IUPAC 2.150b/ISO 8992-1 (non-tempering), was used to determine SFC in the cocoa butter products to identify differences.

### Sample Preparation (SFC Procedure)

The fat sample (cocoa butter product, CB1, CB2 etc.) was melted in an oven at 70° C. Once the sample was fully liquid, it was removed from the oven while using heat resistant gloves and homogenized thoroughly.

Using a Pasteur pipette, a measurement tube (a glass tube with an outer diameter of 10 mm, suitable for introduction into an NMR spectrometer) was filled with 3 ml of sample. To ensure a proper and homogeneous heating, the height of the sample in the tube was at least 5 mm below the outside surface of a heating block in which the measurement tube was placed. For measurement in parallel at different temperatures, one measurement tube was used per each measurement temperature per sample.

### Thermal Pretreatments (SFC Procedure)

The filled measurement tubes were placed in a rack and put back in the oven at 70° C. (or at least at 20° C. above the melting temperature of the fat) for 15 minutes to ensure that any previous crystal memory was erased.

Before measuring the SFC, the fat sample was tempered to stabilize the crystal structure. This was done by placing the samples in temperature controlled blocks at different temperatures.

Measurement tubes were placed in temperature-controlled blocks at 0° C. for 60 minutes. The time was measured with a stopwatch. After that time, each measurement tube was moved to a desired measurement temperature for 30 minutes. The temperatures used to compare the samples in Tables 2A, 2B and 2C were: 40, 35, 30, 25, 20, 15 and 10° C. The higher the temperature the lower the SFC.

### Measurement (SFC Procedure)

The measurement tubes were each separately introduced into a calibrated Bruker™ Minispec MQ20 (0.4 T, 20 MHz), i.e. a pulsed NMR spectrometer. The Bruker™ Minispec MQ20 has pre-loaded software for measurement of SFC. Using the pre-loaded software, the SPE measurements detailed above (in Tables 2A, 2B and 2C) were obtained.

On all SPE retentates, an increase in N20, and an increase in N25, was identified. N20 means the SFC in weight % at 20° C. in a non-tempering SFC procedure. N25 means the SFC in weight % at 25° C. in a non-tempering SFC procedure, and so on for other temperatures where in NXX “XX” is the temperature. Without wishing to be bound by theory, it is believed that this increase in N-value is caused by the FFA reduction.

For the samples after DAG removal (i.e. the higher temperature, R2 reaction conditions) a small further increase for N20 and N25 is observed.

On the deodorized sample (CB5Deso), this increase is not visible, and the N30 increased to some 2%. This increase is an indication of interesterification. Interestification leads to cocoa butter products with less beneficial crystallization profiles and taste properties. With a less beneficial crystallisation profile (e.g. a BCI value below a certain level), it can be difficult to properly temper chocolate containing the cocoa butter, and/or the chocolate can be less shiny, and/or the chocolate can take relatively longer to solidify, and/or the chocolate can shrink less in a mould leading to difficulties in demoulding.

FIGS. 2A-E show SFC differences for the different CB samples before and after application of SPE. With reference to FIG. 2A, CB1 shows the SFC profile of CB1 without SPE treatment. CB1R1 shows the SFC profile of CB1 after treatment according to R1. CB1R2 shows the SFC profile of CB1 after treatment according to R2. FIGS. 2B-2E show the corresponding SFC profiles for CB2-CB5. FIG. 2E additionally shows the SFC profile for CB5 having been subjected to deodorization (and not SPE) (CB5Deso).

Further tests were undertaken to compare the effect of different FFA levels with each other. In FIGS. 3A-C, SFC results for the input and the output of SPE are given for the different FFA levels. Samples CB1, CB2, CB3 and CB4 had a similar range for the SFC, which differed from the CB5 sample which started with a higher FFA content. For CB5 there was some improvement, but less than for CB1, CB2, CB3 and CB4.

FIGS. 3A-E show SFC comparisons for samples starting with different FFA levels under different reaction conditions. FIG. 3A shows the SFC profiles for the starting materials CB1-CB5. FIG. 3B shows the SFC profiles for CB1-CB5 after treatment according to R1, compared with CB5 having been subjected to deodorization (and not SPE) (CB5Deso). FIG. 3C shows the SFC profiles for CB1-CB5 after treatment according to R2, compared with CB5 having been subjected to deodorization (and not SPE) (CB5Deso).

Crystallization Index for the Products after FFA Reduction

Analysis of the Bühler Crystallization Index was conducted at Cargill® Cocoa and Chocolate. The Bühler Crystallization Index is measured on a Bühler MultiTherm™.

FIG. 4 shows the BCI (Bühler Crystallization Index) for samples CB1-CB5 pre and post treatments. All tested samples had the same end FFA weight %. The BCI values indicate the following: BCI 1=Extremely poor crystallization; BCI<3: not recommended, very bad; 3<BCI<4: Not recommended; 4<BCI<5 recommended, good quality; BCI>5: excellent quality

The results shown in FIG. 4 indicate that the SPE processes (including but not limited to R1 and R2) did not have a detrimental effect on the crystallization properties of the cocoa butter (BCI measurement reproducibility +/−0.3). Specifically, with the high FFA crude butter (CB5), the SPE processes resulted in a significant improvement of the BCI, likely due to the significant FFA reduction. The SPE at higher temperatures (R2), that also removed some DAG, resulted in an even greater increase of the BCI, showing better crystallization properties.

In contrast, deodorization (as described under the “deodorization” heading) of the same butter (CB5) resulted in significantly poorer BCI, most likely due to interesterification caused by the elevated temperature together with high acidity during this process (and lack of a degumming pre-step). The results are consistent with the SFC curves in FIG. 2. Deodorization was only tested for CB5 as a comparison.

### Conclusions

The findings of the non-limiting examples can be summarised as follows:
FFA can be removed from cocoa butter with both processes (SPE and deodorization).
SFC analysis for the samples from SPE (R1 and R2) showed an increase for the N20 and N25, while with deodorization this difference was not found.
SFC at 30° C. showed a difference between deodorization and SPE (R1 and R2). With deodorization an increase to some 2% was found, which indicated interesterification.
BCI analysis confirmed the above observations, showing improvement with SPE (R1 and R2). In contrast, after deodorization, crystallization behaviour worsened.
Comparison of the FFA levels showed that for most of the FFA levels the SFC after SPE (R1 and R2) was comparable, while significant differences were visible for the samples with 4% FFA also after FFA removal via SPE and even more after deodorization.
To evaluate if this observation is due to interesterification, or the presence of more DAG removal, additionally DAG removal via SPE (R2) was tested. The temperature of the SPE evaporator was increased to 240° C. for DAG removal. GPC confirmed the DAG removal.
The SFC results showed further increases in the SFC content for the DAG reduced samples. Also, for the CB5 sample with the highest FFA in the starting material this was the case, but the SFC line was still a bit below the other samples. (FIGS. 3A, 3B and 3C)
BCI analysis on the DAG reduced samples (subjected to R2) confirmed that also the DAG removal will still improve the crystallization properties beyond what is achieved via the FFA removal already.
In the absence of a bleaching step, the products still had suitable levels of impurities.

SPE and deodorization were able to remove FFA. SPE at increased temperature (R2) also removed a portion of DAG.

SFC results show that there is a benefit in using SPE (R1 and R2) processes on the final product properties.

It was also found that the starting material (CB5) with relatively high FFA, after FFA removal, showed a different SFC profile and even more when also some DAG was removed at higher SPE temperature (R2).

The results were confirmed with BCI tests at Cargill® Cocoa and Chocolate for the FFA removal samples (R1) and the FFA+DAG removal samples (R2). Without wishing to be bound by theory, the crystallization differences are related to FFA and/or DAG content, rather than origin.

The present inventors surprisingly discovered that SPE processing of cocoa butters provides a beneficial effect on BCI. The effect is proportional to the starting FFA content. The effect is most likely due to the reduction in FFA while preventing interesterification and additional hydrolysis (which would have occurred at higher temperatures, such as in a deodorization apparatus). The effect of DAG and/or MAG reduction (with different SPE conditions employed) further improved the SFC profiles.

If the starting FFA % is high, conventional deodorization (as described under the “deodorization” heading) requires such time/temperature combinations (for example, from 1 to 6 hours at temperatures of from 200 to 270° C.) that interesterification is very significant and completely destroys the crystallization properties of the cocoa butter.

The present results demonstrate that SPE is a solution to reduce FFA and/or DAG in cocoa butter. In particular, SPE can beneficially be used without additional steps of bleaching, and/or deodorization, and/or degumming. The present invention therefore simplifies processing steps to the formation of refined cocoa butters.

Whilst the non-limiting examples relate to cocoa butter, similar or the same results are expected in treating a shea butter, a mango kernel oil, an illipe nut oil or a sal nut oil with the same or a similar SPE process.

### Example 2

A crude cocoa butter from Ivory Coast with the properties below was processed in an SPE at the conditions listed below. The crude cocoa butter had the following characteristics:
Origin: Ivory Coast
Crop year: 2021
Starting FFA: 2.2% w/w
Starting AI: 78.4

The crude cocoa butter was subjected to short-path evaporation, under different conditions. Short path evaporation was undertaken using a KD-2 Unit from the short path evaporator producing company UIC. The feed temperature was set to 80° C. and the condenser temperature to 70° C. Evaporator temperature, pressure and throughput were varied as shown in Table 3. The different conditions along with the residual FFA and Aroma Index of the end products (under the different conditions) are shown in Table 3.

TABLE 3
Different SPE conditions resulting in different FFA and AI levels

| Evaporator | Pressure | | | | | | |
|---|---|---|---|---|---|---|---|
| KD-2 | residue | Feed rate | | | | | |
| Heating Unit | sight glass | calculated | | Residual | Residual | FFA | |
| (setpoint) | (P4) | by scales | Feed rate | FFA | AI | Reduction | AI |
| ° C. | mbar | kg/h | Kg/h · m² | % | No unit | ppt | Reduction |
| 120 | 0.008 | 5 | 50 | 1.81 | 4.69 | 0.39 | 94.0% |
| 120 | 0.006 | 5.1 | 51 | 1.73 | 5.72 | 0.47 | 92.7% |
| 130 | 0.005 | 5.1 | 51 | 1.31 | 2.48 | 0.89 | 96.8% |
| 145 | 0.005 | 5.1 | 51 | 0.75 | 1.31 | 1.45 | 98.3% |
| 145 | 0.005 | 5.1 | 51 | 0.73 | 0 | 1.47 | 100.0% |
| 145 | 0.003 | 5.1 | 51 | 0.49 | 2.69 | 1.71 | 96.6% |
| 130 | 0.007 | 5.1 | 51 | 1.45 | 3.58 | 0.75 | 95.4% |
| 175 | 0.002 | 5.1 | 51 | 0.18 | 2.26 | 2.02 | 97.1% |
| 210 | 0.008 | 10 | 100 | 0.09 | 0 | 2.11 | 100.0% |
| 200 | 0.008 | 10.1 | 101 | 0.11 | 1.18 | 2.09 | 98.5% |
| 190 | 0.008 | 10.1 | 101 | 0.13 | 0.43 | 2.07 | 99.5% |
| 175 | 0.008 | 10.1 | 101 | 0.25 | 0.33 | 1.95 | 99.6% |
| 160 | 0.008 | 10.1 | 101 | 0.55 | 1.92 | 1.65 | 97.6% |
| 145 | 0.007 | 10.1 | 101 | 1.28 | 1.7 | 0.92 | 97.8% |
| 130 | 0.008 | 10.1 | 101 | 1.76 | 4.21 | 0.44 | 94.6% |
| 130 | 0.009 | 10.2 | 102 | 1.79 | 4.77 | 0.41 | 93.9% |
| 135 | 0.008 | 10.2 | 102 | 1.61 | 2.03 | 0.59 | 97.4% |
| 130 | 0.037 | 20.2 | 202 | 2.20 | 12.41 | 0.00 | 84.2% |
| 152 | 0.021 | 20.7 | 207 | 1.76 | 3.04 | 0.44 | 96.1% |
| 145 | 0.02 | 20.8 | 208 | 1.91 | 3.04 | 0.29 | 96.1% |
| 170 | 0.057 | 30.4 | 304 | 1.68 | 6.12 | 0.52 | 92.2% |
| 190 | 0.193 | 30.4 | 304 | 1.83 | 5.21 | 0.37 | 93.4% |

The data from Table 3 is illustrated in FIG. 5.

The Aroma Index was measured as described in Rostagno, W., Reymond, D., Viani, R. (1970), “Characterization of deodorized cocoa butter,” Revue internationale de la chocolaterie, 25: 352-353.

The data from Table 3 and FIG. 5 leads to at least the following conclusions:
Depending on the pressure, temperature and feed rate per evaporator surface area, the FFA and Aroma Index reduction can be fine-tuned.
Large (>80%) reductions in Aroma Index can be achieved for moderate to small FFA reductions, if the evaporator temperature and pressure are set appropriately.
Significant Aroma Index reduction (>80%) can be achieved even at pressures as high as 0.2 mbar.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example aspects of the invention have been described, the scope of the appended claims is not intended to be limited solely to these examples. The claims are to be construed literally, purposively, and/or to encompass equivalents.

1. A process for removing impurities from an edible fat, wherein the edible fat is a cocoa butter, a shea butter, a mango kernel oil, an illipe nut oil or a sal nut oil, the process comprising the step of subjecting the edible fat to a short-path evaporation on a short-path evaporation equipment having an evaporator surface, wherein the short-path evaporation is performed:
at a pressure of below 1 mbar;
at an evaporator temperature in the range of from 80 to 280° C.; and, with a feed rate per unit area of the evaporator surface of the short-path evaporation equipment in the range of from 5 to 500 kg/h·m²;
to form a retentate edible fat and a distillate;
wherein the process does not comprise the step of bleaching the edible fat, and/or subjecting the edible fat to clay filtration.

2. The process of claim 1, wherein the edible fat is a cocoa butter.

3. The process of claim 1, wherein the edible fat is a crude edible fat, wherein the crude edible fat has not previously been refined.

4. The process of claim 3, wherein the crude edible fat has not previously been deodorized, or bleached, or degummed, or deodorized and bleached, or deodorized and degummed, or bleached and degummed, or deodorized and bleached and degummed.

5. The process of claim 1, wherein the process removes free fatty acids (FFA) from the edible fat.

6. The process of claim 1, wherein the process removes diacyl glycerides (DAG) from the edible fat.

7. The process of claim 1, wherein the process reduces the Aroma Index of the starting material by at least 70%, as expressed by the Aroma Index method.

8. The process of claim 1, wherein the short-path evaporation is performed at a pressure below 0.01 mbar.

9. The process of claim 1, wherein the short-path evaporation is performed at a temperature of from 80 to 140° C.

10. The process of claim, wherein the short-path evaporation is performed at a temperature of from 140 to 220° C.

11. The process of claim 1, wherein the short-path evaporation is performed at a temperature of from 220 to 280° C.

12. The process of claim 1, wherein the process does not comprise the step of deodorizing the edible fat by treatment with steam; optionally, wherein the process does not comprise the step of deodorizing the edible fat by treatment with steam at a temperature of from 160 to 280° C.

13. The process of claim 1, wherein the short-path evaporation is performed under the following conditions:
an operating pressure of 0.001 mbar (plus or minus 10%) and an operating temperature of from 120 to 140° C.; or,
an operating pressure of 0.01 mbar (plus or minus 10%) and an operating temperature of from 130 to 150° C.; or,
an operating pressure of 0.1 mbar (plus or minus 10%) and an operating temperature of from 150 to 170° C.

14. The process of claim 1, wherein the process does not comprise the step of degumming the edible fat.

15. The process of claim 1, wherein the process does not comprise the step of drying the edible fat.

16. The process of claim 1, wherein the process consists of subjecting the edible fat to a short-path evaporation, after filtering the edible fat to remove solid matter.

17. A retentate edible fat obtained from, or obtainable from, the process of claim 1.

18. A method of using short-path evaporation on an edible fat, wherein the short-path evaporation conditions comprise a pressure below 1 mbar, a temperature of from 80 to 280° C., and a feed rate per unit area of the evaporator surface of a short-path evaporation equipment of from 5 kg/h·m² to 500 kg/h·m², wherein the short-path evaporation reduces free fatty acids (FFA) content from the edible fat, wherein the edible fat is a cocoa butter, a shea butter, a mango kernel oil, an illipe nut oil or a sal nut oil.

19. The method according to claim 18, wherein the use does not comprise bleaching the edible fat, and/or subjecting the edible fat to clay filtration.

20. The method according to claim 18, wherein the edible fat is a cocoa butter.

21-24. (canceled)
